(19) United States
(12) Patent Application Publication
(10) Pub. No.: US 2013/0057045 A1
(43) Pub. Date: Mar. 7, 2013

(54) Pulsed Water-Jet Apparatus

(71) Applicants: Gregory Oliver Valler, Toowoomba (AU); Peter John Rubie, Toowoomba (AU)

(72) Inventors: Gregory Oliver Valler, Toowoomba (AU); Peter John Rubie, Toowoomba (AU)

(21) Appl. No.: 13/634,248

(22) PCT Filed: Mar. 24, 2011
(86) PCT No.: PCT/AU11/00330

§ 371 Date: Nov. 14, 2012

(30) Foreign Application Priority Data
Mar. 25, 2010 (AU) 2010901258

(51) Int. Cl. E21C 25/60; B05B 1/08

(52) U.S. Cl. 299/29; 239/101

(57) ABSTRACT

A pulsed water-jet apparatus comprising a high pressure water pump delivering water to a nozzle and a means of interruption disposed at or near the nozzle periodically interrupting the flow of water passing through the nozzle thereby generating a pulsed water-jet. An accumulator is disposed between the pump and the nozzle, wherein the accumulator is a high pressure accumulator storing energy between pulses of the pulsed water jet and the pressure drop at the accumulator inlet due to the release of each pulse of the pulsed water jet is less than twenty percent.

### TECHNICAL FIELD

This invention relates to a pulsed water-jet apparatus. In particular this invention is directed towards a pulsed water-jet apparatus that delivers high energy “slugs of water”, which is suitable for use in mining applications such as rock breakage.

### BACKGROUND

Attempts have been made to utilise a pulsed water jet system to break large rocks (boulders) in mining applications.

One such attempt is shown using a rotating disc with fingers that interrupted a continuous high pressure water jet to achieve pulsed flow. A problem with this system is that a large percentage of the jet's energy is wasted when deflected by the fingers. Because of this substantial wastage of energy, the maximum jet diameter that could be achieved was about 3.4 mm.

Another attempt is shown in U.S. Pat. No. 4,863,101 (Pater et al.) where an apparatus for the repetitive production of pulsed liquid jet relies on discrete volumes, or slugs, of liquid that are accelerated to high velocities utilizing energy stored by compressing the liquid. Liquid is forced into a pressure vessel (chamber) already filled with liquid to effect the compression. A slug of liquid is ejected from the pressure vessel into a cumulation nozzle by the energy stored in the compressed liquid when a valve (plunger) is rapidly opened. This valve which interrupts the fluid flow is disposed on the upstream side (or pressure vessel side) of the nozzle. The valve is able to open only once an unseating force exceeds a closing bias, and then opens rapidly by an opening force generated by the compressed liquid. One of the disadvantages of this apparatus is that nearly all of the energy stored is released with each pulse and this must occur to reset the valve. This is a characteristic of the valve actuation mechanism used which relies on a substantial drop in pressure to allow the valve to reset. This means that the pressure at the inlet of the pressure chamber fluctuates significantly, possibly by 70-80%. This significant fluctuation in pressure is disadvantageous for two reasons. Firstly the high pressure fluctuations will lead to reduced pressure vessel life due to fatigue, and secondly it results in low overall efficiency of the device.

The present invention seeks to provide a pulsed water-jet apparatus that can ameliorate at least some of the disadvantages of the prior art.

### SUMMARY OF INVENTION

According to a first, aspect the present invention consists in a pulsed water-jet apparatus comprising:
a high pressure water pump delivering water to a nozzle;
a means of interruption disposed at or near said nozzle periodically interrupting the flow of water passing through said nozzle thereby generating a pulsed water-jet; and
an accumulator disposed between said pump and said nozzle, wherein said accumulator is a high pressure accumulator storing energy between pulses of said pulsed water-jet and the pressure drop at the inlet of said accumulator due to the release of each pulse of said pulsed water-jet is less than twenty percent.

Preferably said means of interruption is a rotating disc with at least one hole therein, said disc disposed adjacent to the exit of said nozzle.

Preferably said nozzle has a section parallel to the direction of flow that in length is no greater than its exit diameter.

Preferably said section parallel to the direction of flow has a length of about half said exit diameter.

According to a second aspect the present invention consists in a pulsed water-jet apparatus comprising:
a high pressure water pump delivering water to a nozzle;
a means of interruption disposed at or near said nozzle periodically interrupting the flow of water passing through said nozzle thereby generating a pulsed water-jet; and
a high pressure accumulator is disposed between said pump and said nozzle, wherein said means of interruption is disposed downstream of said nozzle.

Preferably said means of interruption is a rotating disc with at least one hole therein, said disc disposed adjacent to the exit of said nozzle.

Preferably water is sealed in said accumulator between pulses by maintaining a clearance of less than ten microns between said rotating disc and said nozzle.

Preferably said nozzle has a section parallel to the direction of flow that in length is no greater than its exit diameter.

Preferably said section parallel to the direction of flow has a length of about half said exit diameter.

Preferably at least one hydrostatic bearing is disposed downstream of said disc that exerts a substantial force, and this force drops to zero as said least one hole of said disc passes said nozzle.

According to a third aspect the present invention consists in a water gun for delivering high energy pulses'of water for fragmenting rock, said pulses of water generated by periodically interrupting a stream of high pressure water as it exits a nozzle of said gun, and wherein energy is stored within said gun between pulses of water, said stream of high pressure water emanates from a high pressure accumulator being fed by a pump and said energy is stored within said accumulator, wherein said stream is periodically interrupted by a means of interruption disposed downstream of said nozzle.

Preferably said nozzle has a section parallel to the direction of flow that in length is no greater than its exit diameter.

Preferably said section parallel to the direction of flow has a length of about half said exit diameter.

Preferably said means of interruption is a rotating disc with at least one hole therein, said disc disposed adjacent to the exit of said nozzle.

Preferably water is sealed in said accumulator between pulses by maintaining a clearance of less than ten microns between said rotating disc and said nozzle.

Preferably at least one hydrostatic bearing, is disposed downstream of said disc that exerts a substantial force, and this force drops to zero as said least one hole of said disc passes said nozzle.

### BRIEF DESCRIPTION OF DRAWINGS

FIG. 1 is a front perspective view of a first embodiment of a pulsed water jet apparatus of the present invention.

FIG. 2 is a reduced front exploded perspective view of the pulsed water jet apparatus shown in FIG. 1.

FIG. 3 is a front perspective sectional view through a central vertical plane of the pulsed water-jet apparatus shown in FIG. 1.

FIG. 4 is an enlarged front perspective sectional view of the accumulator, nozzle and disc components of the pulsed water-jet apparatus shown in FIG. 1.

FIG. 5 is an even larger front perspective sectional view of the nozzle and disc components of the pulsed water-jet apparatus shown in FIG. 4.

FIG. 6 is a reduced front perspective view of the pulsed water-jet apparatus with its high pressure pump.

### DESCRIPTION OF PREFERRED EMBODIMENTS

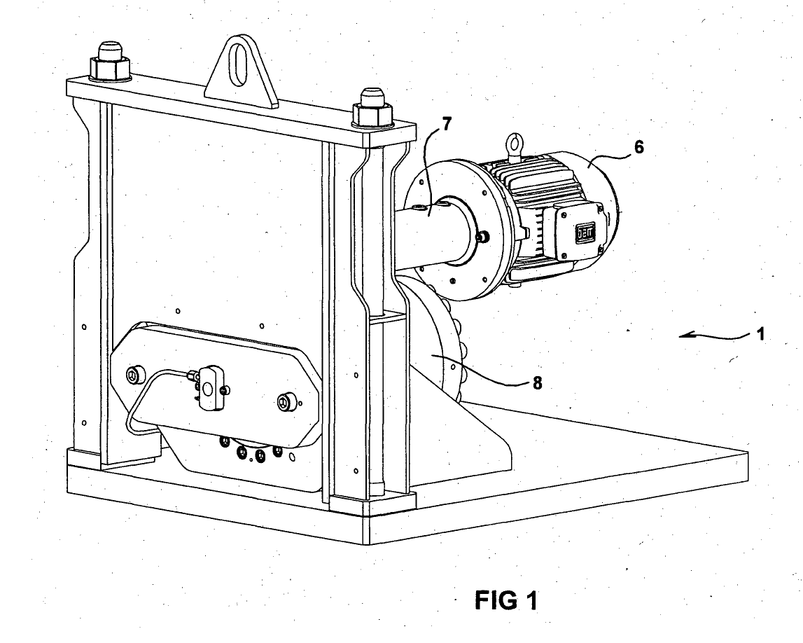

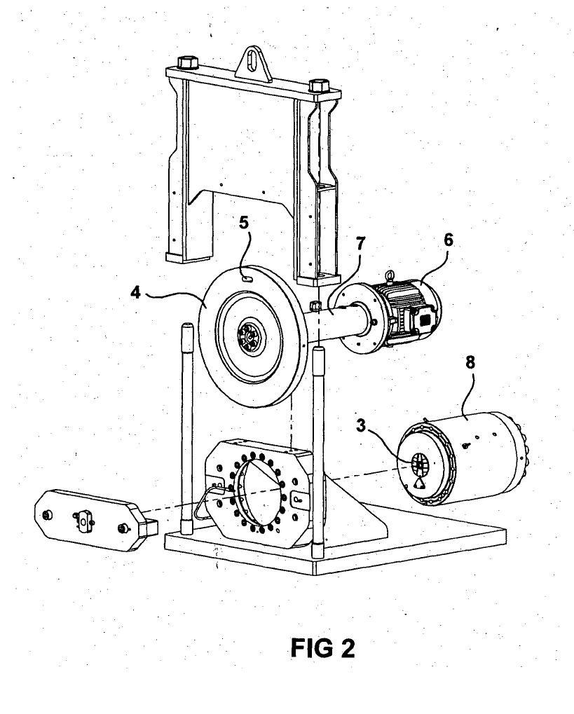

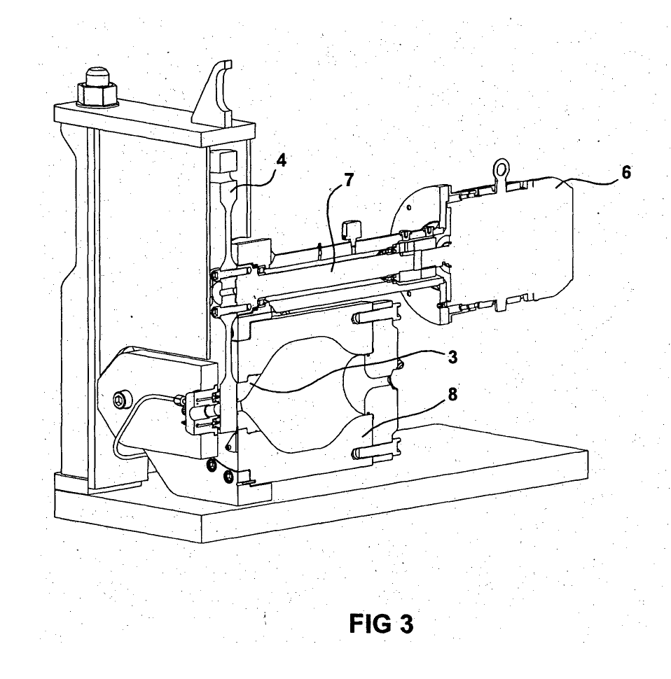

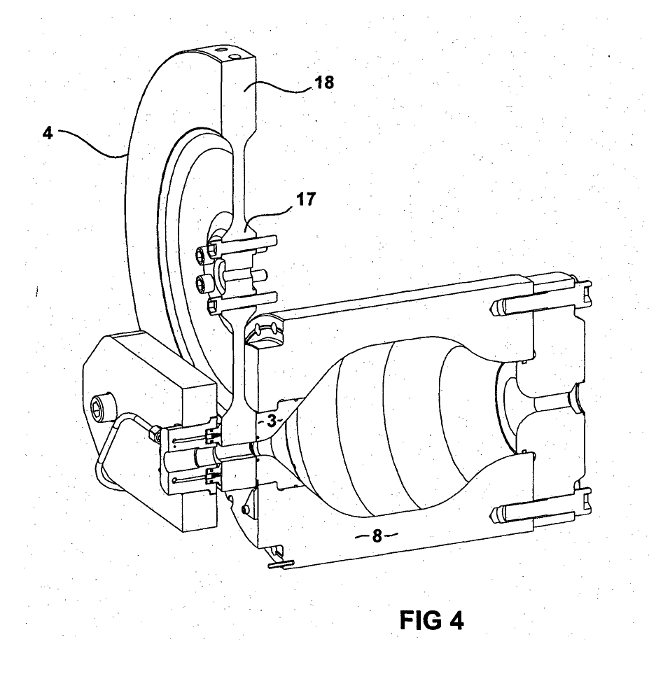

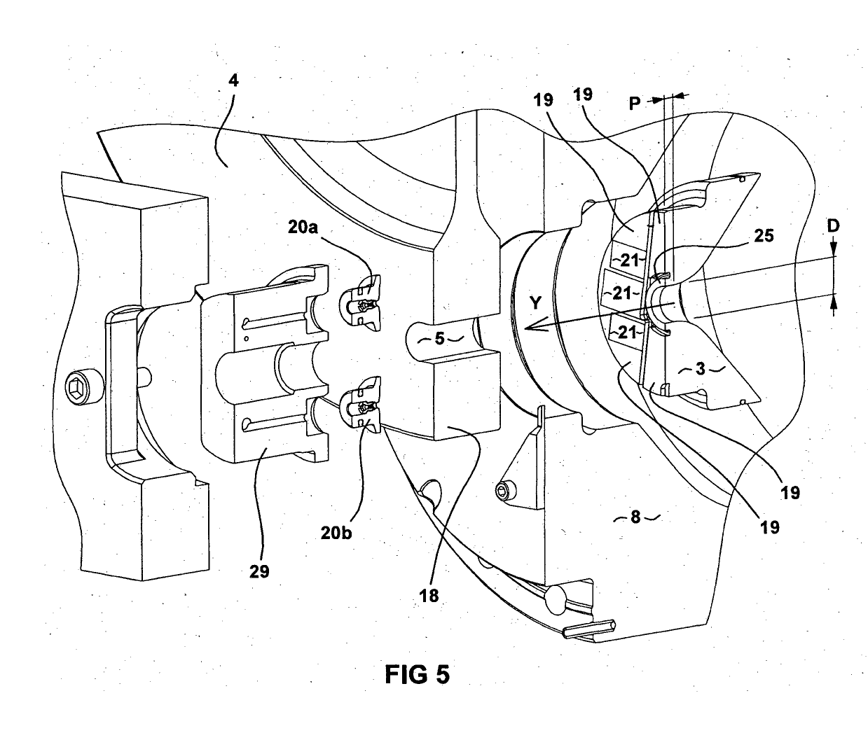

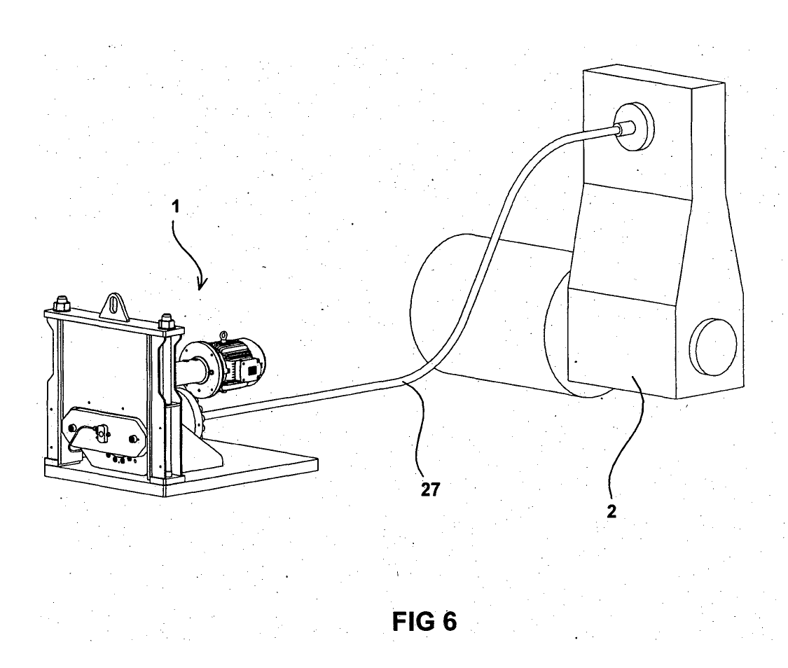

FIGS. 1 to 6 depict a first preferred embodiment of a pulsed water-jet apparatus 1 in accordance with the present invention.

Pulsed water-jet apparatus 1 comprises of a “high pressure” pump 2 delivering water to a nozzle 3 via an accumulator 8. A “means of interruption” in the form of rotating disc 4 with a slotted hole (aperture) 5 is disposed adjacent to the exit of nozzle 3. In this embodiment only a single hole 5 is shown, but it should be understood that in other not shown embodiments disc 4 may have a series of slotted holes.

In this embodiment, rotating disc 4 is rotated by a variable speed electric motor 6 via shaft 7. The rotating disc 4 periodically interrupts the flow of water passing from pump 2 to nozzle 3 thereby generating a pulsed water-jet exiting nozzle 3. Water is pulsed, as it can only pass through rotating disc 4 when hole 5 momentarily aligns with nozzle 3.

A high pressure accumulator 8 is disposed between pump 2 and nozzle 3. As a result of accumulator 8, apparatus 1 stores energy between pulses of the pulsed water-jet, and thus is able to deliver high energy “slugs of water” or “water-bullets”.

In this preferred embodiment, the water is supplied from the pump at about 230 litres per minute at a pressure of about 800 bar. The diameter of nozzle 3 is about twenty millimetres. When disc 4 is rotated at about 3600 revolutions per minute it will deliver approximately sixty “2000 Joule” slugs of water per second.

As previously mentioned accumulator 8 is used to store energy between pulses. Accumulator 8 should be sized to ensure that the drop in pressure at the accumulator inlet due to the release of water pulses is kept to a minimum, and should be less than twenty percent. This is both to reduce the effects of water hammer and to maximise the efficiency of the pulse. The pressure drop due to the release of each pulse of pulsed water-jet however should more preferably be less than ten percent and ideally be less than five percent. The time that nozzle 3 is open, for should preferably be less than 600 microseconds, and more preferably less than 200 microseconds, as the effective size of accumulator 8 is limited by the speed of sound in water.

The rotation speed of disc 4, the length of slotted hole 5, the diameter of nozzle 3, the pressure in accumulator 8 and the number of slots 5 (if more than one slot exists) determine the frequency of the pulsed “slug of water” and the energy per slug of water (or bullet).

The length of section P of nozzle 3 is important to the efficiency of the pulsed water. This section P is the section of nozzle 3 towards its exit that runs parallel to the direction of flow Y. The length of section P should be kept as “minimal” as possible. The longer the parallel section of nozzle 3, the less efficient the pulse. This is due to the fact that water in this parallel section P impedes the acceleration of water leaving accumulator 8. In a preferred embodiment this section P should have a length no greater than the diameter D of nozzle 3, and preferably P should be about half the diameter D.

Water is sealed in accumulator 8 between pulses by maintaining a very small clearance between rotating disc 4 and seal-face 25 of the housing of nozzle 3. The small clearance (or gap) should be less than ten microns to limit water leakage. In this embodiment this small clearance is maintained by a combination of hydrostatic, hydrodynamic and squeeze bearings.

Downstream and adjacent to disc 4 there is disposed hydrostatic bearings 20a,20b within housing 29 that exert a force for example of 3500N that exceeds the pressure of nozzle 3, and this force drops to zero as hole 5 of disc 4 passes nozzle 3, and a pulse or “slug of water” is ejected.

Two hydrodynamic bearings 21 are formed into the face of the housing of nozzle 3. When disc 4 is rotating at high speed these generate a force that balances the excess of force generated by the two opposing hydrostatic bearings 20a and 20b and maintain a gap of approximately ten microns. A large flat area on face of the nozzle 3 acts as a squeeze bearing 19 as the hole 5 passes nozzle 3 and the force on disc 4 due to nozzle 3 drops to zero.

All of the surfaces associated with the bearings must be flat and preferably aligned to within one to three microns. For example, disc 4 may be aligned to within ten microns and the bearing forces dynamically align it to within one to three microns.

Flatness over the contact area of disc 4 is achieved by providing a thick outer rim 18, and in this embodiment the thick outer rim 18 is preferably about fifty millimetres thick.

Whilst nozzle 3 may in not shown embodiments be integral with accumulator 8, this may cause distortion in excess of twenty micron. However, more preferably as shown in this embodiment the nozzle 3 is separate to accumulator 8, thereby allowing for adjustment of the location of seal-face 25, so the face of nozzle 3 could be ‘tuned’ flat to under one and a half micron.

Also in this embodiment disc 4 is able to float axially in the shaft bearings to allow it to rest at the correct distance from nozzle 3.

The bearing supports, accumulator support, opposing hydrodynamic support and the base plate support are all designed to not induce misalignment of shaft 7 as the pressure forces fluctuate.

Disc 4 is thinned between hub 17 and outer rim 18 to allow it to flex and compensate for any misalignment that may still be present.

In the abovementioned embodiment a variable speed electric motor 6 has been employed to vary the speed of disc 4 for trials and experimentation of the apparatus 1. However, in other not-shown embodiments, and in commercial specific mining applications, the rotating disc or other rotating “means of interruption” may be rotated by a single speed motor rather than by a variable speed motor.

In other not shown embodiments, and in particular for substantially smaller nozzle diameters, different “means of interruption” could be employed. For example, a “needle assembly” periodically interrupting flow from the rear of the nozzle 3 exit could be employed instead of disc 4 to generate the pulsed water. Such “needle assembly” may for instance be operably actuated by water flow passing through the pulsed water-jet apparatus.

The terms “comprising” and “including” (and their grammatical variations) as used herein are used in inclusive sense and not in the exclusive sense of “consisting only of’.

1. A pulsed water-jet apparatus comprising:
a high pressure water pump delivering water to a nozzle;
a means of interruption disposed at or near said nozzle periodically interrupting the flow of water passing through said nozzle thereby generating a pulsed water-jet, and an accumulator disposed between said pump and said nozzle, wherein said accumulator is a high pressure accumulator storing energy between pulses of said pulsed water-jet and the pressure drop at the inlet of said accumulator due to the release of each pulse of said pulsed water jet is less than twenty percent.

2. A pulsed water-jet apparatus as claimed in claim 1, wherein said means of interruption is a rotating disc with at least one hole therein, said disc disposed adjacent to the exit of said nozzle.

3. A pulsed water-jet apparatus as claimed in claim 1, wherein said nozzle has a section parallel to the direction of flow that in length is no greater than its exit diameter.

4. A pulsed water-jet apparatus as defined in claim 3, wherein said section parallel to the direction of flow has a length of about half said exit diameter.

5. A pulsed water-jet apparatus comprising:
a high pressure water pump delivering water to a nozzle;
a means of interruption disposed at or near said nozzle periodically interrupting the flow of water passing through said nozzle thereby generating a pulsed water-jet, and a high pressure accumulator is disposed between said pump and said nozzle, wherein said means of interruption is disposed downstream of said nozzle.

6. A pulsed water jet apparatus as claimed in claim 5, wherein said means of interruption is a rotating disc with at least one hole therein, said disc disposed adjacent to the exit of said nozzle.

7. A pulsed water jet as claimed in claim 6, wherein water is sealed in said accumulator between pulses by maintaining a clearance of less than ten microns between said rotating disc and said nozzle.

8. A pulsed water-jet apparatus as claimed in claim 6, wherein said nozzle has a section parallel to the direction of flow that in length is no greater than its exit diameter.

9. A pulsed water-jet apparatus as claimed in claim 8, wherein said section parallel to the direction of flow has a length of about half said exit diameter.

10. A pulsed water-jet apparatus as claimed in claim 6, wherein at least one hydrostatic bearing is disposed downstream of said disc that exerts a substantial force, and this force drops to zero as said at least one hole of said disc passes said nozzle.

11. A water gun for delivering high energy pulses of water for fragmenting rock, said pulses of water generated by periodically interrupting a stream of high pressure water as it exits a nozzle of said gun, and wherein energy is stored within said gun between pulses of water, said stream of high pressure water emanates from an accumulator being fed by a pump and said energy is stored within said accumulator, wherein said stream is periodically interrupted by a means of interruption disposed downstream of said nozzle.

12. A water gun as claimed in claim 11, wherein said nozzle has a section parallel to the direction of flow that in length is no greater than its exit diameter.

13. A water gun as claimed in claim 12, wherein said section parallel to the direction of flow has a length of about half said exit diameter.

14. A water gun as claimed in claim 11, wherein said means of interruption is a rotating disc with at least one hole therein, said disc disposed adjacent to the exit of said nozzle.

15. A water gun as claimed in claim 14, wherein water is sealed in said accumulator between pulses by maintaining a clearance of less than ten microns between said rotating disc and said nozzle.

16. A water gun as claimed in claim 14 wherein at least one hydrostatic bearing is disposed downstream of said disc that exerts a substantial force, and this force drops to zero as said at least one hole of said disc passes said nozzle.
